(19) United States
(12) Patent Application Publication
(10) Pub. No.: US 2024/0029458 A1
(43) Pub. Date: Jan. 25, 2024

(54) A METHOD FOR AUTOMATED DETERMINATION OF PLATELET COUNT BASED ON MICROSCOPIC IMAGES OF PERIPHERAL BLOOD SMEARS

(71) Applicant: DICELLA SP. Z O.O., Krakow (PL)

(72) Inventors: Aleksandra KUBICA-MISZTAL, Krakow (PL); Krzysztof MISZTAL, Krakow (PL); Jacek HAJTO, Warszawa (PL)

(73) Assignee: DICELLA SP. Z O.O., Krakow (PL)

(21) Appl. No.: 18/250,877

(22) PCT Filed: Oct. 29, 2021
(86) PCT No.: PCT/IB2021/060058

§ 371 Date: Apr. 27, 2023

(30) Foreign Application Priority Data
Oct. 31, 2020 (PL) P.435842

(51) Int. Cl. G06V 20/69; G06V 10/36; G06V 10/20; G06V 10/86; G06V 10/26

(52) U.S. Cl. CPC G06V 20/698; G06V 20/695; G06V 10/36; G06V 10/255; G06V 10/86; G06V 10/273

(57) ABSTRACT

A method for analysing microscopic images of a blood smear allowing to determine the number of thrombocytes in a tested sample. The present disclosure uses an algorithm which allows for differentiating between platelets from other blood cells (including erythrocytes), and then counts the quantity of thrombocytes (number/μl) and determines their size (μm). The method includes providing a grayscale microscopic image of platelets, segmenting and analysing the image, wherein the step of segmentation and analysis of the image comprises analysing light regions of the image and analysing dark regions of the image, including detecting distinctive regions in the image using a maximally stable external regions algorithm; calculating for each light and dark region identified its convex hull and filtering the results obtained by shape; removing nesting regions; identifying aggregates; classifying cells into platelets and other blood constituents; and determining the number of platelets and masks thereof.

### PRIOR ART

Blood is a body fluid that transports oxygen, hormones and other nutrients and helps maintain temperature of the body and of the immune system. It is also responsible for removing end products of metabolism and carbon dioxide. Blood is composed of plasma, erythrocytes (red blood cells), thrombocytes (platelets), leukocytes (white blood cells) and lymphocytes.

Thrombocytes, also known as platelets (PLT), are fragments of cells that circulate in the blood and live for about 10 days, to be then destroyed by macrophages, mainly in the spleen and liver. The middle of the night and morning hours are platelet activation periods, when they can cause serious cardiovascular diseases such as myocardial infarction and stroke. Platelets are useful in case of trauma, as they adhere to the wound site or to the walls of damaged vessels, releasing chemicals that cause wounds or vessels to clot and close. Immediately, 13 different clotting factors are activated in a cascade sequence.

Thrombocytopenia is defined as a platelet count below 150×10³ per μl. In many cases, it is detected coincidentally when CBC tests are done due an incidental doctor's visit. The etiology of this condition is not clear, and further research is required. Based on the mechanism of its emergence, thrombocytopenia may be divided into the so-called central thrombocytopenia, caused by decreased platelet production in the bone marrow, and peripheral thrombocytopenia, caused by increased destruction of thrombocytes. The latter group includes spontaneous or heparin-induced thrombocytopenia (Trombocytopenia indukowana heparyną-zasady rozpoznawania i leczenia, [“Heparin induced thrombocytopenia-principles of diagnosis and treatment”], M. Wąsowicz, M. Marineri, A. Vegas, Anestezjologia i Ratownictwo, 2009). It should be noted that heparin and its derivatives are part of a drug group that is among those most commonly used in hospital practice. It is used for example during vascular and cardiac surgical procedures. According to the author of the paper cited above, heparin-induced thrombocytopenia (HIT) is increasingly frequently recognised as a complication of heparin therapy. This disease may be chronic and mild or very aggressive, especially in children. Table 1 shows the types of disease symptoms that occur by platelet count.

TABLE 1
The type of symptoms present by platelet count.

| Platelet count [quantity/μl] | Symptoms |
|---|---|
| >50 · 10³ | symptoms rarely occur |
| 30-50 · 10³ | purpura |
| 10-30 · 10³ | even a minor injury may trigger bleeding |
| <5 · 10³ | spontaneous bleeding (so-called |
| | haematological emergency) |

An attempt to assess the prevalence, incidence, and treatment of immune thrombocytopenia in Poland is PLATE survey study, designed to evaluate the prevalence, extent and treatment of spontaneous thrombocytopenic purpura as described in the article Samoistna plamica maloplytkowa-skala problemu [“Spontaneous thrombocytopenic purpura: the scale of the problem” ] (K. Zawilska, Acta Haematologica Polonica, 40(4), 2009). The paper presents a study conducted between October 2007 and September 2008 at 42 centres with 1331 patients enrolled. The annual ITP incidence in Poland, as assessed by the PLATE survey, is 3.5/100,000, which is comparable to studies conducted in Denmark. In 42 Polish centres analysed there were 3228 patients with ITP registered in total. The article Prevalence of immune thrombocytopenia: analyses of administrative data (J. B. Segal, N. R. Powe, Journal of Thrombosis and Haemostasis, 4(11), 2006) concludes, based on studies for a population in the USA corresponding to that in Europe, that the incidence is comparable, which indicates comorbidity. Also, one should note the potential risk of hazardous working conditions in many industries that may generate thrombocytopenia. In the publication entitled Benzen—Dokumentacja proponowanych wartości dopuszczalnych poziomów narażenia zawodowego (G. Lebrecht, S. Czerczak, W. Szymczak, Podstawy i Metody Oceny Środowiska Pracy, 1(35), 2003), the authors discuss the problem of incidence of workers exposed to benzene. As statistics show, these are mainly blood diseases, and in as much as 7% it is thrombocytopenia, and in 3% pancytopenia, a deficiency of all normal morphological constituents.

One known method of counting platelets is the FONIO method, which consist in counting the number of thrombocytes per 1000 red blood cells in a manual peripheral blood smear. Knowing what is the number of red blood cells per mm³, it is possible to estimate the number of thrombocytes. The main disadvantage of this method is the need of manual counting, which is time-consuming, and the result obtained is only an estimate of the number of platelets. Another known method is platelet counting using the hydrodynamic focusing impedance method, used in most available hematology analysers. Erythrocytes are differentiated from thrombocytes only based on differences in volume, which contributes to errors to be described below.

The limitations of differentiating cells by size alone have led to the development of a modern hemocytometer, where thrombocytes are previously fluorescence-labeled to differentiate them from the cells as above (e.g., Sysmex XN-550 hemocytometers, referenced in European patents EP1918709B1, EP2273264B1).

However, manual (optical) thrombocyte count is still one of the more accurate, as well as very inexpensive techniques. This method yields the best results, since the platelet count may be reduced by various artifacts. Therefore, only an eye of an experienced analyst can effectively handle this task.

In healthy patients, hematology analysers show high accuracy in determining the peripheral blood platelet count. However, when interfering factors are present in the blood, it may affect the measurement, so that microscopic assessment of the peripheral blood smear is recommended.

Abnormal results obtained with automated methods are usually due to a pathology, to interference or to a pre-analytical mistake. It is a highly complex process to ensure the quality of blood counts. Especially in pathological cases, the analyser sometimes signals the need for parameter verification itself. Even the most modern analysers are unable to solve all the problems. In order to streamline laboratory work and quality control of results, the International Society of Laboratory Haematology (ISLH) has prepared a draft of necessary guidelines. The recommendations include indications for microscopic examination of first-time blood smears taken from newborns. The ISLH recommendations also include a note on the matchless expertise and experience of staff.

In the era of modern analysers and increasingly accurate measuring devices, high precision platelet count measurement still constitutes a major challenge. Hereinafter, most common errors associated with platelet count determination and artefacts will be presented.

The first of these is due to the high variability in platelet size, some of which correspond to erythrocytes, while others are so small that they generate signals of the same size as contaminating particles, which distorts the results from analysers.

Another cause of the results being determined lower than reality is the presence of a clot in the test sample. In order to exclude the suspicion of pseudothrombocytopenia (aggregation of platelets due to an anticoagulant effect), it is necessary to evaluate the smear using the microscope (mandatory in this case), and to repeat the blood test.

Another cause that generates artefacts is platelet satellitism. The term denotes the phenomenon of platelets flattening on the surface of leukocytes (mainly neutrophils). Again, this artefact may be identified by microscopic evaluation of the peripheral blood smear.

An overestimated platelet count is mainly due to the presence of deformed erythrocytes with a small volume (schistocytes). Again, microscopic evaluation of the specimen is key to confirm their presence.

The above only lists the most common causes of over- and underestimation of platelet counts. It indicates that the automated and microscopy-based methods complement each other and, especially in pathological cases, should be used concurrently.

The problem of identification of bone marrow hematopoietic cells in their developmental cycle is crucial when diagnosing leukemia and its type. In current medical practice, this is done by an expert—a trained laboratory technician. The accuracy of the expert estimate of the number of various cell types present in the smear is difficult to determine. It is only possible to discuss differences in such an estimate done by several experts. According to data from the Institute of Haematology in Warsaw, acceptable differences may be as high as 15%, which can be considered a rough estimate of expert error. The methodology used by most authors is similar. Once individual cells are isolated from the image, a search for diagnostic features that best describe them is performed. These include features based on texture description, cell geometry, and colour distribution. These form a vector to be compared with the prototype obtained at the learning stage. Two types of classifiers are used. The most commonly used distance classifier measures the distance between the current and prototype vectors. The other group includes classifiers that use artificial intelligence to detect intra-group relationships unknown at the beginning of the analysis. The accuracy of bone marrow cell classification is generally poor. The paper Morphological granulometric features of nucleus in automatic bone marrow white blood cell classification (N. Theera-Umpon, S. Dhompongsa, IEEE Transactions on Information Technology in Biomedicine, 11(3), 2007) reports that only 77% accuracy was achieved. In the paper Blood cell identification using a simple neural network (A. Khashman, International Journal of Neural Systems, 18(05), 2008) an accuracy of 99.17% was achieved, however, only cell classification using neural networks was tested, where the cells were pre-processed by selecting specific elements from the images. There are many reasons for such poor accuracy:
cells of the same type vary greatly, while being very similar to cells of another type (e.g. white blood cells);
smear images are highly variable in terms of colour and depend on the chemical treatment and reagents used (they are derived from different instruments);
the process of automated image processing of a bone marrow smear is very difficult and prone to many errors already at the pre-processing stage;
the distance-based or neural network-based classifiers hitherto used have poor accuracy and are very sensitive to noise generated in the images during chemical treatment.

Algorithms for blood count analysis use similar approaches and face similar problems as those described above. In scientific papers, algorithms are reported that are designed to recognise, for instance, white blood cells due to their complex structure (e.g. A neural network-based approach to white blood cell classification, M. Su, C. Cheng, P. Wang, Chun-Yen and Wang, Pa-Chun, The scientific world journal, 2014, 2014; Application of support vector machine and genetic algorithm for improved blood cell recognition, S. Osowski, R. Siroic, T. Markiewicz, K. Siwek, IEEE Transactions on Instrumentation and Measurement, 58(7), 2008; Segmentation of complex cell clusters in microscopic images: Application to bone marrow samples, B. Nilsson, A. Heyden, Cytometry Part A: The Journal of the International Society for Analytical Cytology, 66(1), 2005; Adaptive Neuro Fuzzy Inference System For White Blood Cell Classification, M. Gunasekaran, K. P. Rajesh, S. Karthik, 2nd International Conference on Innovative Research in Engineering and Technology, 2013) and in general all blood constituents (e.g. Neural networks and blood cell identification, E. Micheli-Tzanakou, H. Sheikh, B. Zhu, Journal of Medical systems, 21(4), 1997; Blood Cell Identification Using Emotional Neural Networks, A. Khashman, Journal of Information Science & Engineering, 25(6), 2009). Algorithms for identifying thrombocytes on blood morphology images are among the most advanced (due to the problems described hereinbefore).

Papers are available on using machine learning to solve fundamental problems based on leukocyte images. Authors of the publication Automatic white blood cell classification using pre-trained deep learning models: Resnet and inception, (M. Habibzadeh, M. Jannesari, Z. Rezaei, H. Baharvand, M. Totonchi, Tenth International Conference on Machine Vision (ICMV 2017), 10696, 2018) successfully classify leukocytes using known neural network architecture, while in the publication Comparison of traditional image processing and deep learning approaches for classification of white blood cells in peripheral blood smear images (R. B. Hegde, K. Prasad, H. Hebbar, B. M. K. Singh, Biocybernetics and Biomedical Engineering, 39(2), 2019), the authors focus on classifications of the types thereof.

Patent US20140193892A1, in turn, relates to a microfluidic chip device for measuring optical forces and imaging cells using microfluidic configuration and dynamics. The device has a unified detection system for fluorometry, luminometry and spectrometry. Patent US20200256783A1, in turn, describes a method and apparatus for unsupervised segmentation of a colour microscopic image of an unstained sample and digital staining of segmented histological structures. This patent uses a method of staining thrombocytes following exposure to modulated ultrasound.

Chinese patent CN108961208 discloses a segmented leukocyte counting system consisting of an image acquisition module for dissolving a blood sample in a blood sample, dissolving red blood cells in a blood sample using a lysate; a pre-operational image module used to perform white blood cell image removal and adopt a maximum inter-class variance method to obtain an optimal segmentation threshold; a cell determination module used to obtain the binarization process according to the optimal segmentation threshold, obtain the binary image and set the cell area discrimination function according to the binary image, as well as obtain the ROI region of cell aggregation; a cell segmentation module used to extract cells in each ROI region of cell aggregation according to the binary processing image, wherein the cells are mapped to the grayscale image of white blood cells. This method involves generating an image of a blood sample, segmenting and analysing the image.

European patent EP2271937B1 discloses a method for counting platelets in a sample, comprising: placing the sample in a substantially transparent analytical chamber; admixing a dye to the sample, wherein the dye causes fluorescence of the platelets when they are exposed to certain wavelengths of light; illuminating at least a portion of the sample with light having a specific wavelength; imaging the sample; identifying platelets based on their fluorescent emission; determining the mean value of the fluorescent emission intensity for individual identified platelets; identifying platelet aggregates in the sample; counting the platelets within each platelet aggregate, using the mean value of the fluorescent emission intensity determined for individual platelets in the sample. The method may also include counting the separated platelets and determining the total number of platelets in the sample as the sum of the platelets in each aggregate and those separated.

Another European patent EP3538887B1 discloses a method for determining the number of thrombocytes in a blood sample, comprising the following steps: providing a capillary blood sample treated with EDTA anti-coagulant upon sample collection; diluting said sample by a dilution factor of 1:10 to 1:2000; incubating the diluted sample; optionally, diluting the incubated sample; and determining the thrombocyte count. The method is performed in an integrated thrombocyte counting device.

European patent EP2246691 B1, in turn, discloses a method and apparatus for counting platelets in a blood sample comprising: mixing the sample with fluorescent markers that bind specifically to thrombocytes and an agent for inhibiting thrombocyte activation; introducing the sample into a chamber having at least one transparent side; taking at least one digital image of the sample using fluorescence microscopy; and counting the thrombocytes present in each image using a computer image processing method.

Thus, there are patents using fluorescent staining for thrombocyte analysis (said patent EP22466911B1, as well as EP2269038B1, U.S. Pat. No. 8,310,659B2). Moreover, methods are also known for differentiating erythrocytes from white blood cells using laser light scattering in an automated hemocytometer (US20170276591A1, US20100035235A1), as well as devices using both of these physical phenomena (JP2005265495A).

The known methods, however, have a high error margin, thus making the thrombocyte count inaccurate.

### SUMMARY

The aspects of the embodiments disclose a method for automatically determining a platelet count based on images of a suspension of peripheral blood smears, comprising providing a grayscale microscopic image of platelets, segmentation and analysis of the image, characterised in that the step of segmentation and analysis of the image comprises:
i. bright region analysis of an image and dark region analysis of an image, comprising the detection of distinctive bright regions and dark regions in an image using a maximally stable external regions algorithm (MSER) Maximally Stable External Regions);
ii. calculation, for each found light region and dark region, its convex hull and filtering the obtained results by shape;
iii. removal of the nesting light and dark regions;
iv. Identification of the aggregates, wherein this step comprises:
   dilation of the dark regions of the image;
   graph analysis—connected components;
   circularity analysis;
v. classification of cells into platelets and other blood constituents;
vi. determination of platelet counts and their masks.

Preferably, the provided microscopic image of the platelets is taken of a suspension of peripheral blood smear placed in a Bürker chamber adapted for manual cell counting.

Preferably, the microscope image is taken at 100× magnification.

Preferably, the cell counting is carried out over the entire surface of the image taken, without taking into account the lines defined by the Bürker chamber, and the result is scaled relative to the area analysed.

Preferably, the conversion of the colour image to grayscale is carried out by transferring the loaded image from the RGB colour space to the HSV color space and selecting a channel, wherein a third channel is preferably used as a single channel image.

Preferably, after conversion of an image to a grayscale image, two complementary images are formed therefrom, wherein a first image is formed by dilation of the grayscale image with a disk-type kernel, preferably with a radius of 8, and a second image is formed by erosion of the grayscale image.

Preferably, the filtering of the obtained results by shape in step [ii.] is performed such that some masks identified by the MSER algorithm with a circularity factor lower than the threshold value are removed.

Preferably, a threshold circularity factor of 0.6 is used.

Preferably, the identified masks from two images are combined into one indexed image, where consecutive numbers represent cell masks.

Preferably, the platelet aggregates are determined based on the number of masks present in a given common component after a morphological close process performed on the previously identified masks.

Preferably, the classification of identified masks representing white cells, aggregates and platelets is performed using a measure of circularity and mask area.

Preferably, when the circularity of a blood constituent in step [iv.] is greater than 0.9, it is classified as a white blood cell.

Preferably, between steps [v.] and [vi.] it comprises an additional step of analysis of the previously determined platelet aggregates, wherein said step comprises:
dilation of the dark regions of the image;
detection of distinctive dark regions in the image using MSER algorithm and obtaining masks;
removal of undesired masks.

Preferably, after taking a microscope image, it is loaded into an analysis program and a conversion of the colour image to a grayscale image is performed.

### Advantageous Effects of the Present Disclosure

Automated analysis of platelet images using computer vision algorithms is challenging for several reasons:
the images available are mainly obtained from microscopic images of the suspension in a Bürker chamber adapted for manual counting, which means that the images are taken at low magnification in order to capture as much surface area as possible, and the lines of the chamber are visible that interfere with the analysis;
often there are clusters of cells, so-called aggregates, which are difficult to separate due to low magnification and merging;
platelets on images take on two basic shapes: dark round spots or bright, slightly larger than the dark ones, resembling white blood cells, which produces significant errors in the analysis.

The present disclosure overcomes the above difficulties and allows for providing reproducible and reliable results.

### DESCRIPTION OF THE FIGURES OF THE DRAWING

FIG. 1 shows microscopic images illustrating the main problems in analysing platelet images.

FIG. 2 shows a diagram of the algorithm mechanism.

FIG. 3 shows the result of the MSER algorithm on an image after using dilation (left) and erosion.

### DETAILED DESCRIPTION

Hereinbelow, with reference to the accompanying figures of the drawing, the method of the present disclosure will be illustrated in an embodiment.

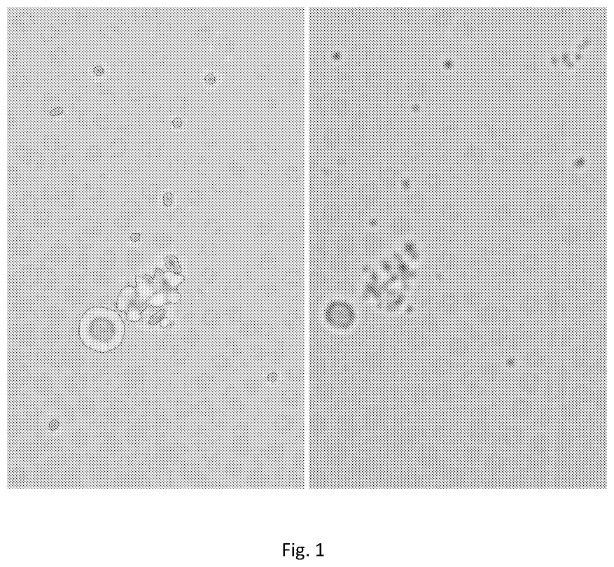

The main problems listed in the previous section of the description in the automated analysis of platelet images using computer vision algorithms are illustrated in FIG. 1. The inventive method allows for overcoming the problems as above.

An important step preceding the counting of thrombocytes is proper preparation of blood samples so that the microscopic images obtained are suitable for analysis. Therefore, the first necessary activity is the proper preparation of the material to be examined. This step comprises:
drawing blood into a tube with EDTA (potassium edetate); ensuring that the blood is drawn to the correct level (recommended by the tube manufacturer) and that there are no clots in the sample;
placing the tube with blood on the hematology mixer for 3 minutes.
Sarstedt S Monovette 2.6 ml K3 EDTA 8% tripotassium solution (1.6 mg EDTA/ml blood) tubes or Sarstedt S Monovette 2.7 ml ThromboExact tubes (0.82 mg Mg2+/ml blood) were used for blood collection during preparation.

The next step is to determine the platelet count on a hematology analyser. A Sysmex XN-1000 analyser was used for the determination.

In the next step, the platelets are analysed. It is important to be able to quickly estimate what area is being analysed, i.e. what is its size. For this purpose, it is useful to use a Bürker chamber, since the lines in the chamber provide good reference points (which facilitates the counting). Accordingly, the embodiment describes the use of a Bürker chamber, which, however, is not necessary, and other embodiments may use any other suitable tools. The important thing here is to know what the magnification is and how that translates into pixel size. The platelet analysis (in the embodiment with the Bürker chamber) is performed, for example, as follows:
From the prepared material, 50 p of blood is added to a special tube containing prolocaine—for a 1:20 blood dilution. The blood is mixed and allowed to stand for 3 minutes, before the hemolysis of the erythrocytes. For this purpose, an erythrocyte hemolysis kit from KABE Labortechnik was used.
The Bürker chamber and coverslip are cleaned with 70% EtOH and the slide is placed on the chamber so that its edges abut against the two side plates.
10 μl of blood is pipetted at the edge of the coverslip and the Bürker chamber is placed in a humidity retaining container for 10 minutes. Then, complete platelet sedimentation occurs.
For a 1:20 dilution, platelets are counted in the area of 5 medium squares (or 16 small squares). The result is the platelet count×1000/μl.

The test should be performed up to 3 hours after the blood draw. EDTA may affect thrombocyte counts, resulting in a falsely reduced platelet count (known as EDTA-dependent pseudothrombocytopenia or pseudothrombocytopenia). In the presence of EDTA, platelets are more likely to clump together and form aggregates, which may be misinterpreted as leukocytes in haematology analysers. If platelet aggregates are found, the blood should be redrawn into a special Thromboexact tube containing magnesium salts, which effectively prevent platelet aggregation without causing changes in other morphological parameters.

This is followed by taking microscopic images. The Bürker chamber, prepared as described above, is placed on the microscope table.

The photographs of the slides on which the algorithm was prepared were taken by the present inventors using a Nikon H 600 L Eclipse 50i microscope, equipped with:
CFI LU Plan Fluor Epi 5×, 10×, 20×, 50×, 100× lenses for bright/dark field, phase and differential interference contrast (DIC) and epifluorescence observations;
eyepieces: standard 10× with large field of view (diaphragm diameter 25 mm. Option: eyepieces 12.5× (diaphragm diameter 16 mm) and 15× (diaphragm diameter 14.5 mm);
Moticam PRO 282 B camera. Camera specification:
   image sensor—SONY ICX-⅔″ color CCD;
   resolution—2588×1960 5.0 million pixels (5 MP) @ 7 fps*;
   pixel size—3.40 μm×3.40 μm;
   exposure time— 1/1000 to 6s;
   Peltier cooling to 10° C. below ambient temperature;
   power supply—Universal power supply (5V);
   supported systems—Microsoft Windows XP/Vista/7; Apple Mac OSX.

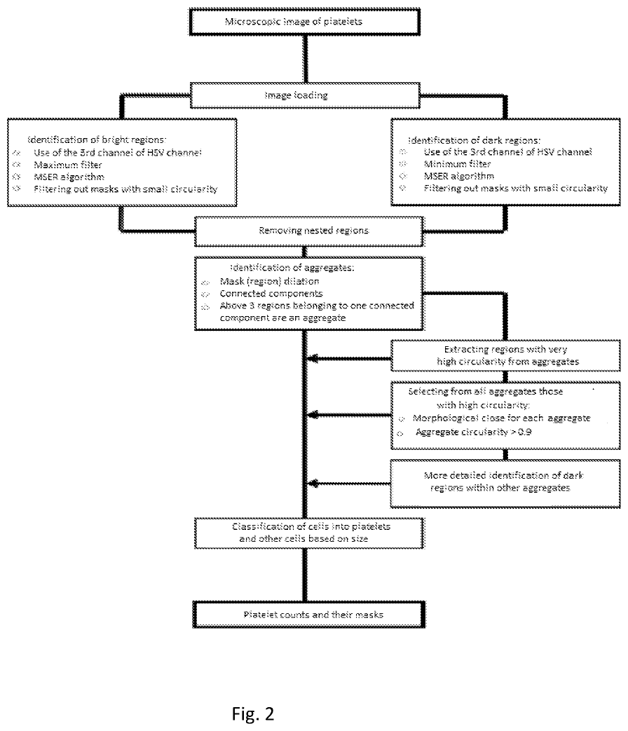

The method according to the present disclosure is essentially based on the detection of distinctive spots (hereinafter referred to as regions) in an image using the maximally stable extremal regions (MSER) algorithm. This yields multiple masks that cover almost all the cells. Unfortunately, sometimes several masks belong to a single cell or the other way round: one large cell contains many smaller masks. This is the case especially when the cell has a heterogeneous structure (e.g. white blood cells). For this reason, the results at this stage need to be filtered accordingly: some masks discarded and some merged. The concept of circularity, a numerical value that describes the degree of similarity of a shape to a circle, is helpful in this task. The mechanism of the algorithm described in the embodiment is shown in FIG. 2.

The version of this algorithm used is the one operating on grayscale images. It works by progressively thresholding the image with a certain step. A series of binary images is then obtained where certain objects appear in multiple images. Such shapes are objects that stand out from the background by being relatively low or high in brightness compared to the surrounding background. Based on the change in area of said shapes, the algorithm determines, for different thresholds, whether it is sufficiently “stable” given the indicated algorithm parameters.

Circularity is a measure determining the degree to which the shape analysed is similar to a circle. Sometimes, circularity is also used to mean compactness, given that shapes that are more compact around the center seem to be more circular. The definition of the circularity measure used is shown by equation 1.

$$𝒞 ( 𝒮 ) := \frac{{μ}_{0 , 0}^{2} ( 𝒮 )}{2 π ( {μ}_{s , 0} ( 𝒮 ) + {μ}_{0 , 2} ( 𝒮 ) )} \qquad ( 1 )$$

μ_{p,q} denotes the central moment (2) and S denotes the analysed shape.

$${μ}_{p , q} ( 𝒮 ) = {\sum }_{( x , y ) ∈ 𝒮} {( x - \overline{x} )}^{p} {( y - \overline{y} )}^{q} , \qquad ( 2 )$$

First, then, the image needs to be converted to grayscale. This is done by converting the original image to the HSV colour scale and selecting the third channel (Value channel). Platelet images generally have a rather low contrast, so to improve cell detection it is performed on two modified images. The first image is generated by dilating a grayscale image with a disk type kernel of radius 8 [this is presented e.g. in the article entitled ImageMagick v6 Examples—Morphology of Shapes available at https://legacy.imagemagick.org/Usage/morphology/]. The result of this operation is the same as the maximum filter, making the brighter cells more visible. The second image is processed in the same way, only it is subjected to an opposite operation, namely erosion. This, in turns, accentuates dark platelets.

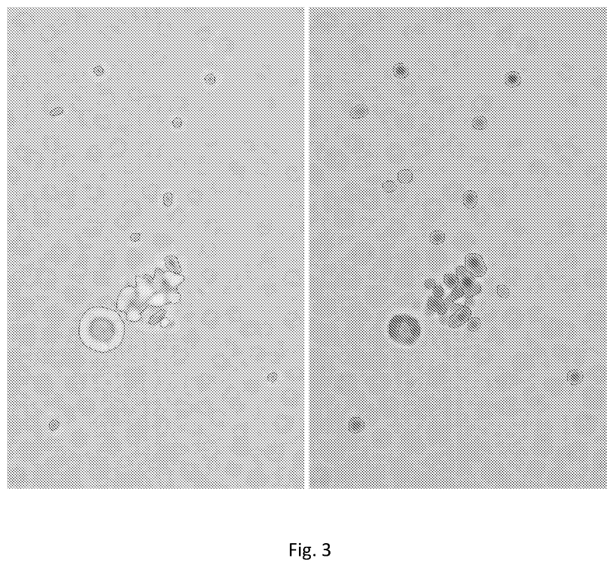

The MSER algorithm is run on images thus prepared. The result of MSER algorithm on the image after using dilation and erosion is shown in FIG. 3). It results in identifying a large number of regions that are potentially platelet cells. For each region identified, its convex hull is calculated. The obtained results are then filtered by shape so that their minimum circularity is 0.6.

At this step, two sets of results are obtained: one favouring bright cells, and the other favouring dark ones. However, certain areas are often comprised in both scores. Moreover, there are a lot of false hits that, for example, identify bright regions among an aggregate of dark cells, since they are relatively “stable” against them.

The first problem is relatively easy to solve: having superimposed one result over another, the individual masks that are inside another are removed. When there are more such masks, it may mean that the mask encompassing them was generated by accident or at the stage of generating a convex hull that dramatically increased its surface area. In this case, this outer mask is removed.

The detection of false hits is based on the assumption that they occur primarily on cell aggregates and on white blood cells due to the highly irregular surface. Therefore, it is necessary to separate the aggregating masks from the individual ones so as to then perform a separate analysis for them. For this purpose, a dilation of the binary image representing all the masks is performed. Then the masks that are located close to each other merge to form a common large component. This is followed by a graph analysis involving the extraction of connected components (the connected component labelling algorithm). More than 3 regions belonging to one connected component are an aggregate. The circularity of these components is then calculated, and where it is greater than 0.9, such a component is counted as a white blood cell. The other are identified as a platelet group and are subject to a more detailed analysis in order to break down the cluster into individual cells.

The aggregates consist primarily of dark cells. In order to determine these, some previous steps are repeated with some modifications. First, the dark regions of the image are enhanced by the minimum (dilation) filter, and then the MSER algorithm with less restrictive parameters is used to obtain more regions from the algorithm. Again, many undesired masks are obtained, but if the boundaries of the aggregate are known, masks outside the region of interest may easily be discarded. Moreover, all masks that have relatively high brightness are also discarded at this step.

The masks obtained (described in the previous paragraph) are combined with the rest of the masks to yield the final result.

1. A method for automatically determining a platelet count based on images of a suspension of peripheral blood smears, comprising providing a grayscale microscopic image of platelets, segmentation and analysis of the image, wherein the step of segmentation and analysis of the image comprises:
i. bright region analysis of an image and dark region analysis of an image, comprising the detection of distinctive bright regions and dark regions in an image using a maximally stable external regions algorithm (MSER);
ii. calculation, for each found light region and dark region, its convex hull and filtering the obtained results by shape;
iii. removal of the nesting light and dark regions;
iv. Identification of the aggregates, wherein this step comprises:
dilation of the dark regions of the image;
graph analysis—connected components;
circularity analysis;
v. classifying cells as platelets and other blood components;
vi. determining the number of platelets and their masks.

2. The method according to claim 1, wherein the provided microscopic image of the platelets is taken of a suspension of peripheral blood smear placed in a Bürker chamber adapted for manual cell counting.

3. The method according to claim 1, wherein the microscope image is taken at 100× magnification.

4. The method according to claim 2, wherein the cell counting is carried out over the entire surface of the image taken, without taking into account the lines defined by the Bürker chamber, and the result is scaled relative to the area analysed.

5. The method according to claim 1, wherein the conversion of the colour image to grayscale is carried out by transferring the loaded image from the RGB colour space to the HSV colour space and selecting a channel, wherein a third channel is preferably used as a single channel image.

6. The method according to claim 1, wherein after conversion of an image to a grayscale image, two complementary images are formed therefrom, wherein a first image is formed by dilation of the grayscale image with a disk-type kernel, preferably with a radius of 8, and a second image is generated by erosion of the grayscale image.

7. The method according to claim 1, wherein the filtering of the obtained results by shape in step [ii.] is performed such that some masks identified by the MSER algorithm with a circularity factor lower than the threshold value are removed.

8. The method according to claim 7, wherein a threshold circularity factor of 0.6 is used.

9. The method according to claim 7, wherein the identified masks from two images are combined into one indexed image, where consecutive numbers represent cell masks.

10. The method according to claim 1, wherein the platelet aggregates are determined based on the number of masks present in a given common component after a morphological close process performed on the previously identified masks.

11. The method according to claim 1, wherein the classification of identified masks representing white cells, aggregates and platelets is performed using a measure of circularity and mask area.

12. The method according to claim 11, wherein when the circularity of a blood constituent in step [iv.] is greater than 0.9, it is classified as a white blood cell.

13. The method according to claim 1, wherein between steps [v.] and [vi.] it comprises an additional step of analysis of the previously determined platelet aggregates, wherein said step comprises:
dilation of the dark regions of the image;
detection of distinctive dark regions in the image using MSER algorithm and obtaining masks;
removal of undesired masks.

14. The method according to claim 1, wherein after taking a microscope image, it is loaded into an analysis program and a conversion of the colour image to a grayscale image is performed.
